(19) United States
(12) Patent Application Publication
(10) Pub. No.: US 2015/0312631 A1
(43) Pub. Date: Oct. 29, 2015

(54) MEDIA BOXES AND RELATED METHODS

(71) Applicant: Antennas Direct, Inc., Ellisville, MO (US)

(72) Inventors: Richard E. Schneider, Wildwood, MO (US); Dale Picolet, St. Louis, MO (US); Corey Feit, St. Louis, MO (US)

(21) Appl. No.: 14/573,934

(22) Filed: Dec. 17, 2014

Related U.S. Application Data
(63) Continuation-in-part of application No. 29/489,120, filed on Apr. 25, 2014.
(60) Provisional application No. 62/044,807, filed on Sep. 2, 2014.

(51) Int. Cl. H04N 21/462; H04N 21/4402; H04N 21/236; H04N 21/472; H04N 21/235; H04N 21/84

(52) U.S. Cl. CPC H04N 21/4622; H04N 21/2353; H04N 21/84; H04N 21/23614; H04N 21/472; H04N 21/440236

(57) ABSTRACT

Disclosed are exemplary embodiments of digital media boxes and related methods. In an exemplary embodiment, a digital media box includes a receiver that receives, via an antenna, signals including metadata and program content from over-the-air broadcast channels. A top portion of the box includes an antenna mount integral thereto for receiving the antenna. The box also includes a controller that combines metadata received by the media box from metadata sources, the combined metadata including but not limited to at least some of the metadata from the over-the-air broadcast channels. The controller provides a dynamic display, on a display device connectible with the digital media box, of at least some of the combined metadata to describe shows scheduled to be presented on the broadcast.

### CROSS-REFERENCE TO RELATED APPLICATIONS

This application claims the benefit of and priority to U.S. Provisional Application No. 62/044,807 filed Sep. 2, 2014. This application also claims the benefit of and priority to U.S. Design Application No. 29/489,120 filed Apr. 25, 2014. The entire disclosures of the above applications are incorporated herein by reference.

### FIELD

The present disclosure generally relates to media boxes and related methods.

### BACKGROUND

This section provides background information related to the present disclosure which is not necessarily prior art.

Numerous entertainment options, including but not limited to television, cable and Internet-based systems and devices, are currently available for providing a wide range of home entertainment capabilities. One such option, broadcast television, has undergone improvement through conversion to digital broadcasts. Digital television signals may be received, e.g., through cable systems and/or over the air.

### SUMMARY

This section provides a general summary of the disclosure, and is not a comprehensive disclosure of its full scope or all of its features.

According to various aspects, exemplary embodiments are disclosed of digital media boxes and related methods. In an exemplary embodiment, a digital media box generally includes a receiver configured to receive, via an antenna, signals including metadata and program content from a plurality of over-the-air broadcast channels. A top portion of the box includes an antenna mount integral thereto for receiving the antenna. The box also includes a controller configured to combine metadata received by the digital media box from a plurality of metadata sources, the combined metadata including but not limited to at least some of the metadata from the over-the-air broadcast channels. The controller provides a dynamic display, on a display device connectible with the digital media box, of at least some of the combined metadata to describe shows scheduled to be presented on the broadcast channels.

In another exemplary embodiment, a digital media box includes top and bottom portions, and an antenna supported on the top portion. A controller between the top and bottom portions is connected with the antenna. The controller is configured to receive, via the antenna, signals including metadata and program content from a plurality of over-the-air broadcast channels, and to play at least some of the metadata and program content in response to user input. The controller is further configured to combine at least some of the metadata from the received signals with metadata received from one or more additional metadata sources, and dynamically display, on a display device, at least some of the combined metadata to describe shows scheduled to be presented on one or more of the broadcast channels.

Also disclosed are methods of providing digital content. In an exemplary embodiment, a method of providing digital content generally includes a digital media box receiving signals including metadata and program content from a plurality of over-the-air broadcast channels. The receiving is performed through an over-the-air antenna mounted on and held by an upper surface of the digital media box. A controller of the box combines at least some of the metadata from the received signals with metadata received by the controller from one or more additional metadata sources. The controller provides, on a display device, a changing slideshow of at least some of the combined metadata to describe shows scheduled to be presented on one or more of the broadcast channels.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an entertainment system including a digital media box in accordance with one example embodiment;

FIG. 2 is a front perspective view of a digital media box in accordance with one example embodiment;

FIG. 3A is a perspective view of a digital media box and antenna mounted thereon in accordance with one example embodiment;

FIG. 3B is a perspective view of a digital media box and antenna mounted thereon in accordance with one example embodiment;

FIG. 3C is a perspective view of a digital media box and antenna mounted thereon in accordance with one example embodiment;

FIG. 4A is a top perspective view of a top portion of a digital media box in accordance with one example embodiment;

FIG. 4B is a top perspective view of a bottom portion of a digital media box in accordance with one example embodiment;

FIG. 4C is a top perspective view of a rear portion of a digital media box in accordance with one example embodiment;

FIG. 5 is a flow diagram of a controller-performed method of providing a dynamic display of show metadata in accordance with one example embodiment;

FIG. 6A is a screenshot of an overlay display in accordance with one example embodiment; and

FIG. 6B is a screenshot of an information display in accordance with one example embodiment.

Corresponding reference numerals indicate corresponding parts throughout the several views of the drawings.

### DETAILED DESCRIPTION

Example embodiments will now be described more fully with reference to the accompanying drawings.

The inventors hereof have recognized that when people attempt to put together home entertainment systems, the results can be less than ideal when entertainment system devices cannot be conveniently positioned and connected with one another. For example, where digital TV is being incorporated into an entertainment system, it is not always easy to find an optimal place for installing an over-the-air antenna to receive broadcast signals. In many cases, an over-the-air (OTA) antenna would be best installed outside the home, or at least inside but close to a window, in order to provide decent reception of OTA broadcast signals. Accordingly, the inventors have developed and disclose herein exemplary embodiments of a digital media box, e.g., a digital video recorder/streaming box, having an antenna mount integral thereto for receiving an OTA antenna. In various embodiments, a digital media box and antenna mounted thereon can be connected, e.g., with a TV or other display device and can provide, e.g., over-the-air digital TV broadcast programming, Internet streaming, and digital video recording.

The inventors hereof have further recognized that before the introduction of digital television, a TV viewer typically discovered content by performing a random channel scan or so-called “channel flipping” in which the viewer rapidly changed the television channel to see what was currently being shown on various channels. The viewer typically settled on a show only after actually seeing at least a bit of that show. In contrast, many currently available programming guides for digital TV provide only show titles and air times. A user may be forced to consciously search for a show he/she is already familiar with, rather than naturally stumbling upon a show that “looks good.” The metadata that is freely available for digital over-the-air (OTA) television programming can be limited to the title of a series of shows and an overarching description of that series, leaving a television viewer scanning through free programming data with no other way of recognizing or evaluating an individual show that is currently scheduled.

Accordingly, the inventors have developed and disclose herein exemplary embodiments of a digital media box having an antenna mount integral thereto for receiving an antenna, where the digital media box is configured to receive signals including metadata and program content from a plurality of over-the-air broadcast channels, and where at least some of the received signals are received via the antenna. The digital media box also includes a controller configured to combine metadata received by the media box from a plurality of metadata sources. The combined metadata includes but is not limited to at least some of the metadata from the over-the-air broadcast channels. The controller is further configured to provide a dynamic display, on a display device connectible with the digital media box, of at least some of the combined metadata to describe program content scheduled to be provided on the broadcast channels. In some implementations, the controller describes the program content in a slideshow that transitions from show to show. Unless otherwise indicated, the term “metadata” is used herein to refer to various types of data descriptive of digital media programs, shows, and/or presentations. Additionally, unless otherwise indicated, the term “show” is used herein to refer to any digital content that might be described in a slideshow or other dynamic display of metadata as described herein. Thus, a “show” may be or include, e.g., a show, program, series, presentation, etc. It should be noted generally that aspects of the disclosure could be implemented in relation to various types of digital content, e.g., video and/or audio content.

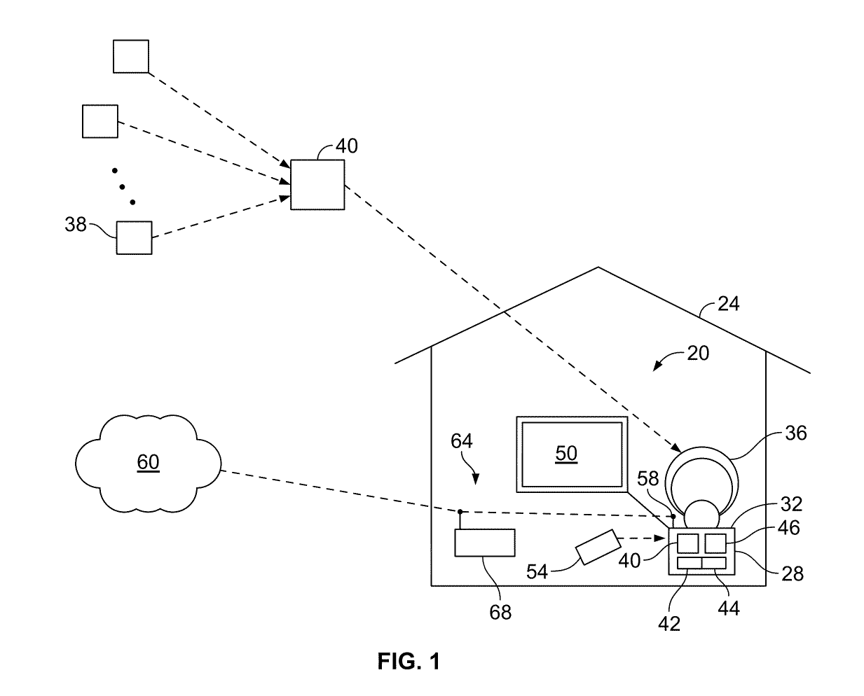

With reference now to the figures, FIG. 1 illustrates an entertainment system 20 embodying one or more aspects of the present disclosure. The entertainment system 20 is situated, e.g., in a user's residence or home, 24 and includes an example embodiment of a media box 28, e.g., a digital video recorder (DVR), etc. The media box 28 has a top portion 32 upon which an antenna 36 is mounted. In various embodiments, the antenna 36 is an over-the-air (OTA) antenna capable of receiving digital media broadcast signals. For example, high-definition television (HDTV) signals from a plurality of TV broadcasters 38 may be multiplexed and broadcast via a transmitter/receiver 40 in accordance with ATSC (Advanced Television Systems Committee) standards. The broadcast stream from each broadcaster 38 includes TV programming content as well as metadata describing the programming content. The metadata may be provided in accordance with the Program and System Information Protocol (PSIP) and may include electronic program guide (EPG) metadata describing shows scheduled for broadcast. The digital media box 28 includes a transmitter/receiver 40, a controller 42, and memory 44 configured to decode the HDTV signals into signal components from each of the broadcasters 38. The digital media box 28 may also include a display adapter 46.

In the present embodiment, the digital media box 28 is connectible with a display device 50, e.g., a digital TV. In other embodiments, a display device may include, e.g., a home computer, a tablet, etc. The display device 50 is operable through the media box 28, e.g., by a user using a remote control device 54. In the present embodiment, the digital media box 28 also has Internet streaming capabilities. The media box 28 thus includes a wireless adapter/transceiver/antenna 58 by which the media box 28 is connectible with the Internet 60. In the present example embodiment, a home wireless network 64 includes a router/access point 68 accessible by computing devices including, but not necessarily limited to, the media box 28, the user's home computer(s), tablet(s), smart phone(s), etc. Additionally or alternatively, in some embodiments, the display device 50 may be a “smart” TV capable, e.g., of connecting with the Internet 60, e.g., through the home network 64. In yet other embodiments, the media box 28 may provide its own network access point whereby it connects with the Internet 60, e.g., through cell towers and/or Internet Service Providers (ISPs). It will be appreciated by those knowledgeable in the art that many configurations of entertainment systems are possible and that such systems could include various types of entertainment system components, connections and/or capabilities. In some embodiments, various capabilities described herein with reference to the media box 28 could be provided in distributed fashion by the media box 28 and one or more additional devices, e.g., a smart TV, personal computer, etc.

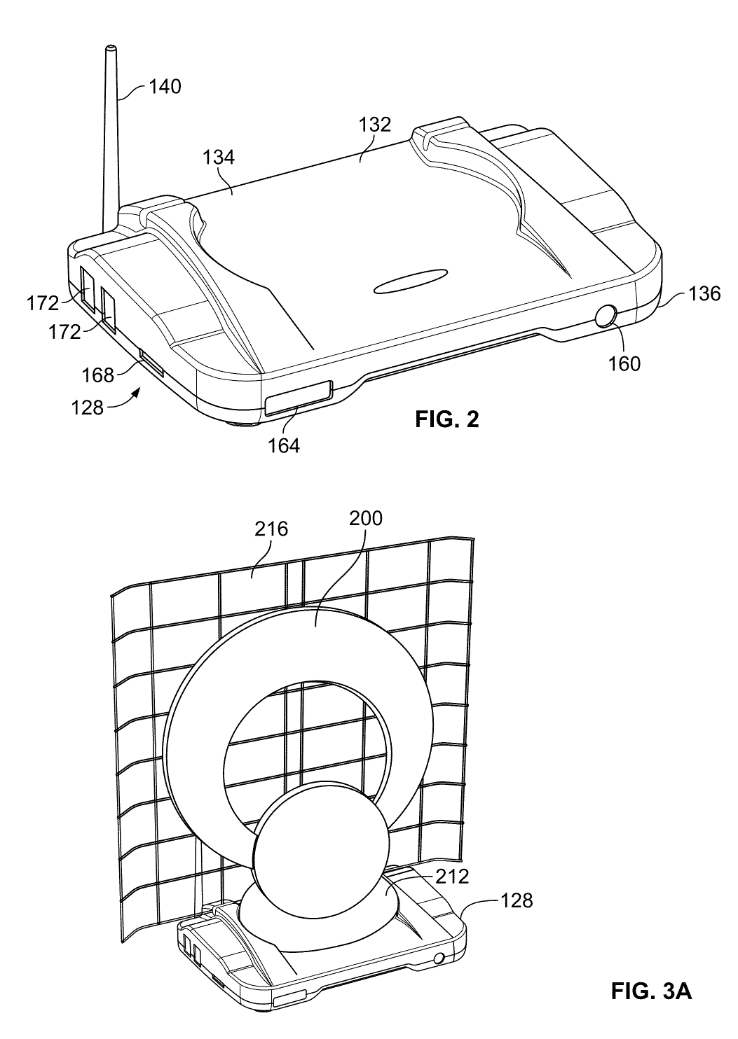

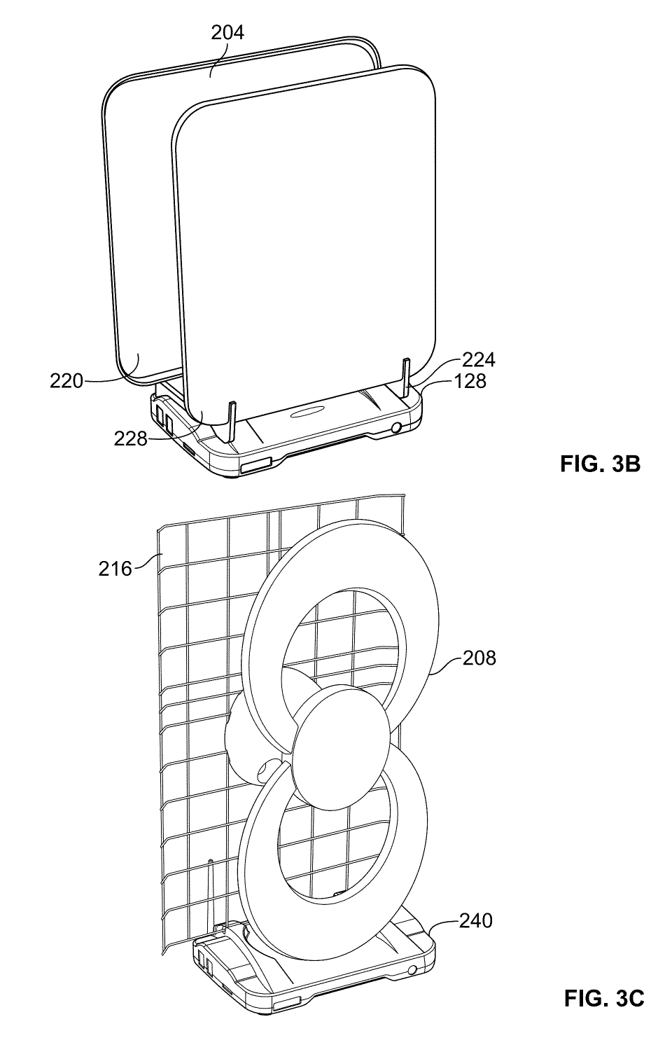

One embodiment of a media box is indicated generally in FIG. 2 by reference number 128. The media box 128 is, e.g., a DVR with streaming capabilities. The media box 128 includes an antenna mount 132 that is integral to a top portion 134 of the media box 128. The media box 128 also includes a bottom portion 136 and a wireless antenna 140. The antenna mount 132 is configured to receive and support an over-the-air antenna, e.g., as shown in FIGS. 3A-3C. As can be seen in FIGS. 3A-3C, the media box 128 is configured to receive and support more than one type of antenna. For example, as shown in FIG. 3A, a medium-range digital TV antenna 200 is mounted on the media box 128. As shown in FIG. 3B, an indoor digital TV antenna 204 is mounted on the media box 128. As shown in FIG. 3C, a long-range indoor/outdoor digital TV antenna 208 is mounted on the media box 128. The antennas 200, 204 and 208 are available from Antennas Direct of Ellisville, Mo., www.antennasdirect.com. The media box 128 and antennas 200, 204, and 208 are examples only, and other or additional antennas may be mounted onto a media box in accordance with various implementations of the present disclosure.

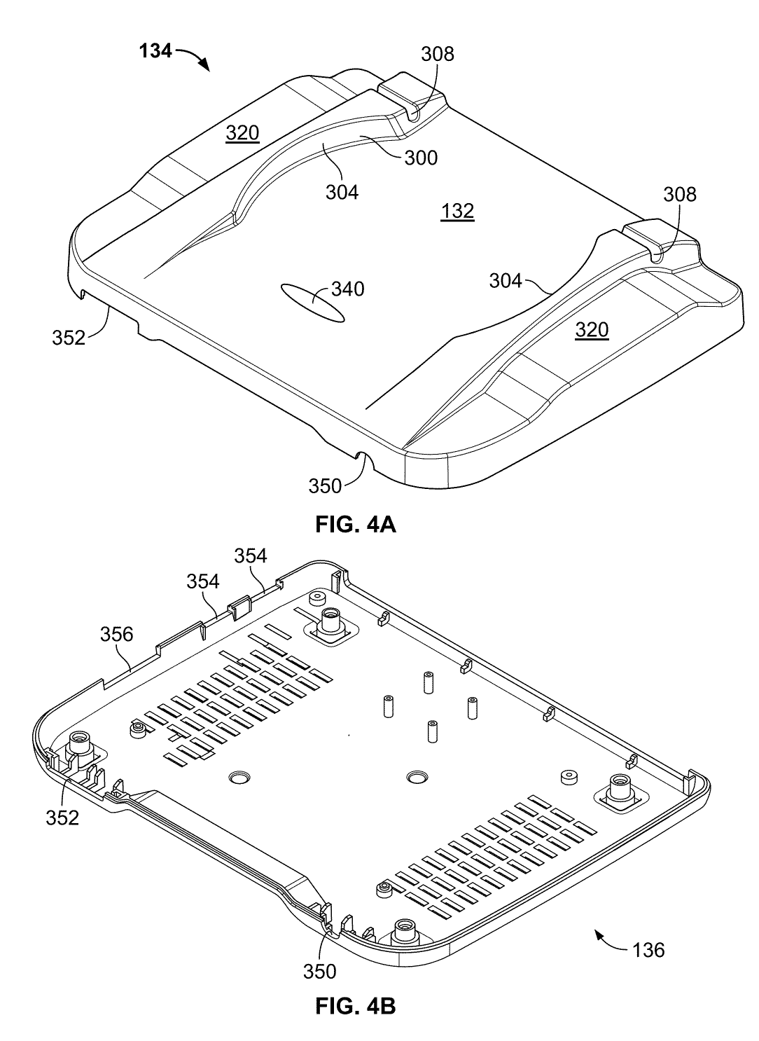

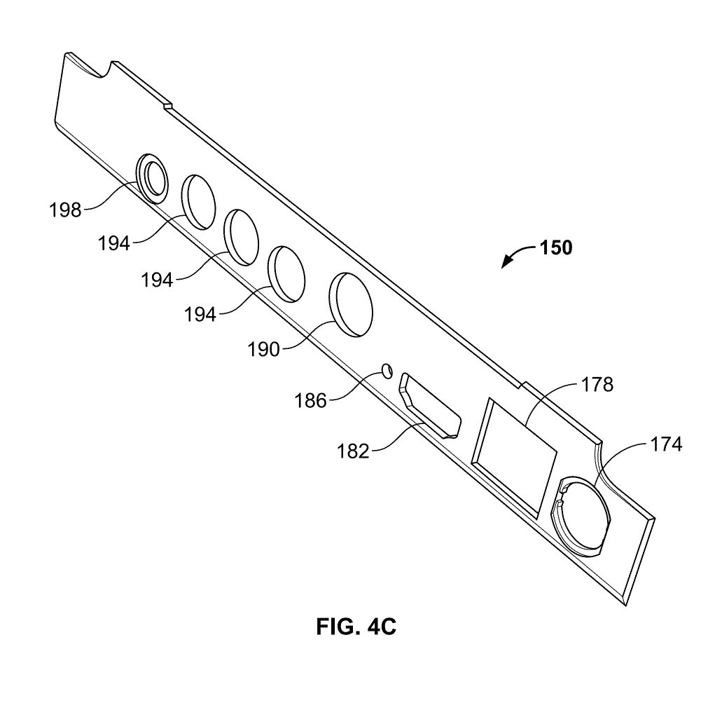

The top portion 134 of the media box 128 is shown in greater detail in FIG. 4A. The antenna mount 132 includes a plurality of surface contours 300 onto, against, and/or into which an antenna may be slid and/or pressed, whereby the antenna is received and supported by the antenna mount 132. For example, referring to FIGS. 3A and 4A, a pair of generally opposed, generally vertical and curved surfaces 304 can support, e.g., a base 212 of the antenna 200. Referring to FIGS. 3A, 3C, and 4A, a pair of slots 308 can support, e.g., a reflector 216 of the antenna 200 or 208. Additionally or alternatively, and as shown in FIGS. 3B and 4A, the slots 308 can support a rear edge 220 of a stand 224 for the antenna 204. A pair of generally parallel surfaces 320 can support, e.g., side edges 228 of the stand 224. As shown in FIGS. 4A and 3C, an indentation 340 can provide, e.g., a resting spot for a lower edge 240 of the antenna 208.

The bottom portion 136 of the media box 128 is shown in greater detail in FIG. 4B. As shown in FIGS. 2, 4A, and 4B, the top and bottom portions 134, 136 of the media box 128 include or cooperatively define therebetween a plurality of openings or holes 160, 164, 168, 172. The openings 160, 164, 168, and 172 are configured (e.g., sized, shaped, located, etc.) for different features or functions. For example, the opening 160 is configured for a power button of the media box 128. The opening 164 is configured to allow a receiver enclosed within the space defined by between the top and bottom portions 134, 136 of the media box 128 to receive communications, instructions, or commands from a remote control (e.g., infrared remote control, etc.). The opening or SD card slot 168 is configured for receiving an SD memory card (secure digital nonvolatile memory card) to allow it to be inserted into and read by a SD memory card reader enclosed within the space defined by between the top and bottom portions 134, 136 of the media box 128. The openings or USB ports 172 are configured for receiving receive USB (Universal Serial Bus) connectors.

FIG. 4C shows a rear portion 150 of the media box 128. As shown in FIG. 4C, the rear portion 150 includes or defines a plurality of openings or holes 174, 178, 182, 186, 190, 194, and 198. The openings 174, 178, 182, 186, 190, 194, and 198 are configured (e.g., sized, shaped, located, etc.) for different features or functions. For example, the opening 174 is configured for receiving a Wi-Fi antenna connector. The opening 178 is configured for receiving a Ethernet connector. The opening 182 is configured for receiving a High-Definition Multimedia Interface (HDMI) connector. The opening 186 is configured for a reset button of the media box 128. The opening 190 is configured for receiving an F-connector, which is a coaxial RF connector. The openings 194 are configured for receiving composite audiovisual (A/V) red, yellow, and white cable connectors. The opening 198 is configured for a power button of the media box 128.

As previously mentioned, various embodiments include a media box that can provide a dynamic display of show metadata, e.g., a slide show that transitions from show to show. In one example embodiment, and referring to FIG. 1, the controller 42 receives and parses PSIP data from regional ATSC broadcast streams. The controller 42 gathers titles and any additional information descriptive of those shows that are slated to be aired within a predetermined time frame, e.g., within the next 16 hours, etc. The controller 42 also performs a search of the Internet 60 (e.g., via the home network 64, etc.) against one or more TV show directories and/or other sources that could provide show metadata in addition to the metadata provided in the PSIP data. Various metadata sources could be searched in various implementations of the disclosure. The controller 42 may download from search results any additional metadata descriptive of the scheduled shows. Such metadata can include, but is not necessarily limited to, extended descriptions, show artwork, genre information, etc. When metadata collection has been completed, the controller 42 may provide a dynamic display, e.g., to replace a home screen background window that otherwise would be displayed on the display device 50. In various embodiments, the dynamic display is a semi-random slideshow of artwork that includes show titles, show descriptions, genre information, and air time. The controller may perform new searches at various times (e.g., every hour, every half hour, etc.) to retrieve any additional metadata and other content that would then be available.

In various embodiments, the controller 42 may execute a software program, e.g., a media player application including one or more scripts, to perform, e.g., periodically, some or all of the processes described and/or exemplified herein. The media application may be written, e.g., in C++ and scripts may be written, e.g., in Python, although other or additional programming languages could be used. One such media player application is XBMC Media Center, although other or additional applications and/or dedicated software and/or firmware could be used. It should be noted generally that other or additional software, firmware and/or hardware could be used to provide various capabilities in accordance with implementations of the present disclosure. Software can take many forms, including but not limited to source, object, and/or executable code that can include and/or refer to a plurality of objects, modules, libraries, services, etc., and that can be stored, distributed, downloaded, combined and/or accessed in many different ways.

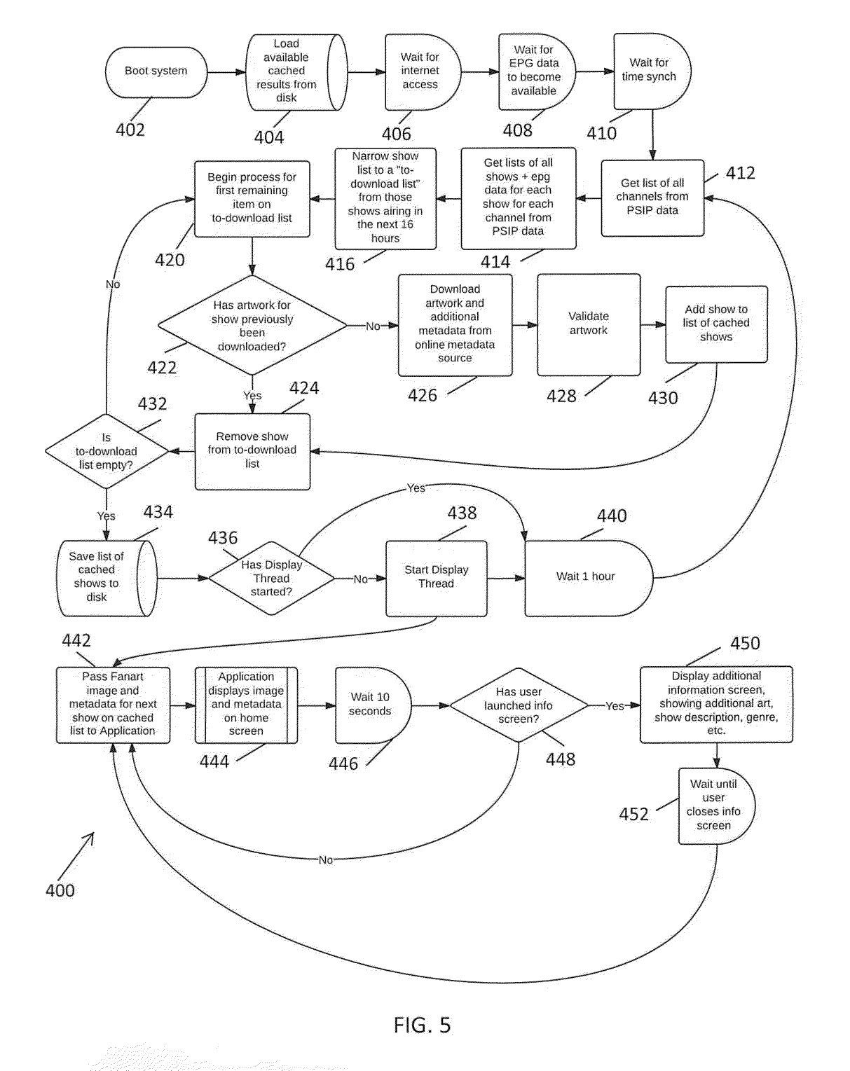

In one example implementation, processes may be performed to supplement and dynamically display program data, e.g., as indicated generally in FIG. 5 by reference number 400. In various implementations, a search may be performed periodically (e.g., every hour, every half hour, etc.) on electronic program guide (EPG) data and other metadata sources to obtain results for dynamic display. Referring to FIG. 5 and to the example media box 28, in process 402 the controller 42 is booted up. In process 404, the controller 42 loads, e.g., from a disk storage cache, any metadata previously collected for shows in previous searches. In process 406, the controller 42 waits while Internet access to online program metadata source(s) is obtained. In process 408, the controller 42 waits for electronic program guide (EPG) data to become available, e.g., from PSIP sources via the OTA antenna 36. In process 410, the controller 42 waits for a “time synch.” For example, a System Time Table (STT) may be provided in the PSIP data whereby data from the broadcasters 38 may be synchronized and may be used, e.g., by DVRs to start and/or stop recording broadcast signals. It should be understood generally that some processes exemplified in FIG. 5 may be performed in various sequences, and that in various embodiments performances of processes exemplified in FIG. 5 may at least partially overlap.

In process 412, the controller 42 obtains a list of available broadcast channels from the PSIP data. In process 414, the controller 42 obtains from the PSIP data, for each broadcast channel, a list of all shows and the EPG data for each of the shows. In process 416, the controller 42 narrows the list of shows to those scheduled for broadcast, e.g., in the next sixteen (16) hours to obtain a “to-download” list of shows, etc. The controller 42 goes through the “to-download” list show by show. For example, in process 420 the controller 42 processes the first show on the “to-download” list. If in process 422 it is determined that artwork and/or additional metadata for that show has previously been downloaded and cached, then in process 424 that show is removed from the “to-download” list. Otherwise, in process 426 the controller 42 downloads additional metadata, e.g., artwork and additional descriptive metadata from online metadata source(s), etc. In process 428, the additional metadata, if any, is validated, e.g., to make sure that a fan art image was downloaded for that show, etc. In process 430, that show is added to a list of shows for which metadata has been downloaded and cached, and in process 424 that show is removed from the “to-download” list. In process 432, it is determined whether any shows remain in the “to download” list. If so, control returns to process 420 to process the next show on the “to download” list.

When the “to download” list is empty, the list of cached shows is saved to disk in process 434 for use in executing a display thread. The controller 42 executes display threads at various times (e.g., every hour, etc.) to provide a changing display of program information, e.g., on the display device 50, etc. Referring again to FIG. 5, if in process 436 it is determined that a display thread has not yet started, then a thread is started in process 438. In process 440, the controller 42 waits, e.g., for the one-hour period, etc. allotted for displaying a thread, before updating PSIP information in process 412 to begin data gathering for an updated thread.

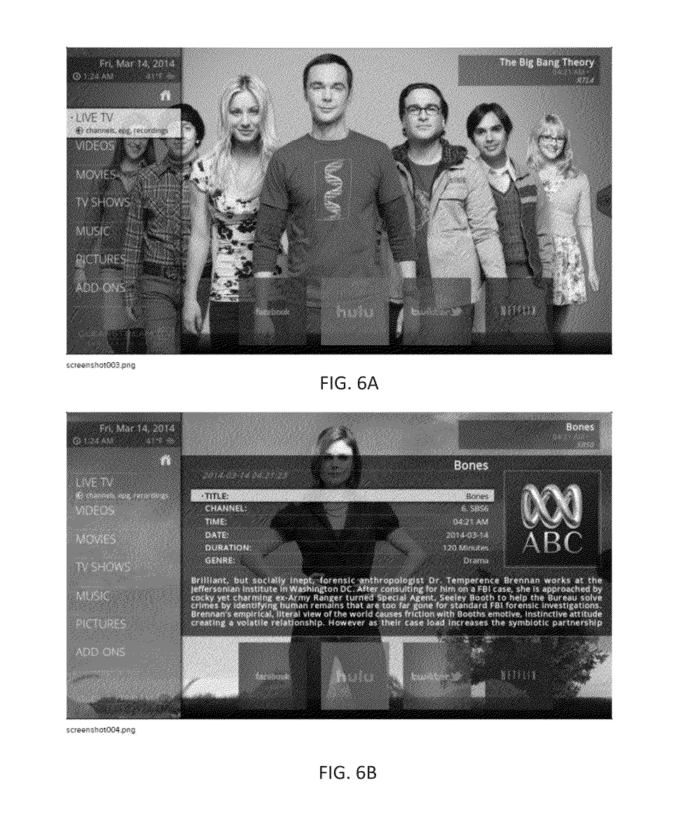

When a thread has been started in process 438, metadata for each show on the list of cached shows may be displayed in turn and for a predetermined time (e.g., for ten (10) seconds, etc.) in a slideshow. For example, in process 442 fan art imagery and other metadata for the first show on the list of cached shows is passed to the media player application. The media player application in process 444 displays the fan art imagery and other metadata for that show, e.g., as an overlay on a home screen displayed by the media player application on the display device 50, etc. An example screenshot of an overlay is shown in FIG. 6A. In process 446, the controller 42 waits for ten seconds, e.g., to allow a user to use the remote control 54 to display an “Info” screen for the show described by metadata in process 444. If in process 448 it is determined that the user has not selected the “Info” screen for the show within the ten-second period, then control returns to process 442 and the controller 42 passes fan art imagery and other metadata for the next show on the list of cached shows to the media player application. If in process 448 it is determined that the user has selected to launch an “Info” screen, then in process 450 the media player application may display additional art, a show description, genre information, etc. for that show. An example screenshot of an “Info” screen is shown in FIG. 6B.

In various implementations, an “Info” screen may also display an option selectable by the user and executable by the controller 42 to record the show, e.g., on just the current day and/or on a periodic (e.g., weekly) basis, etc. Referring again to FIG. 5, in process 452 the controller 42 waits until the user has closed the “info” screen, whereupon control returns to process 442 to display data for the next show on the list of cached shows. The thread may repeat the slideshow describing the shows on the list of cached shows, e.g., until the one-hour wait time before updating the list has expired, etc.

A slideshow may be displayed in various ways. For example, in some implementations, metadata for shows may be displayed in the order in which the metadata was collected and/or added to the “to download” list or the list of cached shows. Additionally or alternatively, metadata for shows may be selected for download in, and/or rearranged into, a desired order by one or more categories, for example, by preferred time slots (e.g., if prime time between 7:00 pm and 10:00 pm is preferred, etc.) by genre, by broadcaster, etc. In various embodiments, the controller 42 may provide a slideshow in a random sequence by shuffling the shows. In some embodiments, the controller 42 provides a user with an option to select and/or adjust the speed at which a slideshow transitions. Various embodiments may also provide a recommendation service, e.g., whereby a user can be alerted to upcoming shows previously selected by the user, and/or whereby the user can receive recommendations of new shows based, e.g., on previous user selections of shows, etc.

A slideshow provided in accordance with various aspects of the present disclosure can transition from show to show, thereby providing for the user a mechanical emulation of “channel flipping.” A user thus can naturally stumble upon shows airing on TV not only at the current time, but also over the course of, e.g., the next sixteen hours, etc. Such a slideshow can render a home background screen more dynamic and attractive.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A digital media box comprising:
a receiver configured to receive, via an antenna, signals including metadata and program content from a plurality of over-the-air broadcast channels;
a top portion having an antenna mount integral thereto for receiving the antenna; and
a controller configured to:
combine metadata received by the digital media box from a plurality of metadata sources, the combined metadata including at least some of the metadata from the over-the-air broadcast channels; and
provide a dynamic display, on a display device connectible with the digital media box, of at least some of the combined metadata to describe shows scheduled to be presented on the broadcast channels.

2. The digital media box of claim 1, further comprising an antenna affixed to and held by an upper surface of the top portion.

3. The digital media box of claim 1, further comprising a wireless transceiver configured to provide access to the Internet, the controller further configured to obtain from the Internet additional metadata relating to the metadata from the over-the-air broadcast channels.

4. The digital media box of claim 1, wherein the combined metadata includes metadata received from the Internet.

5. The digital media box of claim 1, wherein the controller is configured to describe the program content in a slideshow that transitions from show to show.

6. The digital media box of claim 5, wherein the controller presents the slideshow as an overlay on a home screen background window on the display device.

7. The digital media box of claim 5, wherein the slideshow transitions randomly from show to show.

8. The digital media box of claim 1, wherein the received signals include electronic program guide (EPG) data from a plurality of broadcasters.

9. A digital media box comprising:
a bottom portion
a top portion configured to support an antenna thereon;
a controller between the top and bottom portions and connectible with the antenna that is supported by the top portion the antenna, the controller configured to receive, via the antenna, signals including metadata and program content from a plurality of over-the-air broadcast channels, and to play at least some of the metadata and program content in response to user input;
the controller further configured to:
combine at least some of the metadata from the received signals with metadata received from one or more additional metadata sources; and
dynamically display, on a display device, at least some of the combined metadata to describe shows scheduled to be presented on one or more of the broadcast channels.

10. The digital media box of claim 9, wherein an upper surface of the top portion is configured to support and hold more than one type of over-the-air antenna.

11. The digital media box of claim 9, further comprising a HDTV antenna supported by the top portion.

12. The digital media box of claim 11, where the HDTV antenna is affixed to and held by an upper surface of the top portion.

13. The digital media box of claim 9, wherein the user input is received from a user remote control device.

14. A method of providing digital content comprising:
a digital media box receiving signals including metadata and program content from a plurality of over-the-air broadcast channels, the receiving performed through an over-the-air antenna;
a controller of the box combining at least some of the metadata from the received signals with metadata received by the controller from one or more additional metadata sources; and
the controller providing, on a display device, a changing slideshow of at least some of the combined metadata to describe shows scheduled to be presented on one or more of the broadcast channels.

15. The method of claim 14, further comprising the controller displaying additional metadata pertaining to a show selected by a user in response to the slideshow.

16. The method of claim 14, further comprising the controller searching the Internet to access at least some of the additional metadata sources.

17. The method of claim 14, wherein the one or more additional metadata sources include fan art imagery.

18. The method of claim 14, wherein the over-the-air antenna includes a HDTV antenna mounted on and held by an upper surface of the digital media box.

19. The method of claim 14, wherein the digital media box includes a digital video recorder (DVR).

20. The method of claim 14, further comprising the controller shuffling the slideshow.
